(19) United States
(12) Patent Application Publication
(10) Pub. No.: US 2011/0255020 A1
(43) Pub. Date: Oct. 20, 2011

(54) PIXEL DRIVING DEVICE, LIQUID CRYSTAL DISPLAY HAVING THE SAME AND PIXEL DRIVING METHOD

(76) Inventors: Chun-Lin Yu, Zhongli City (TW); Kuan-Hung Liu, Taoyuan City (TW); Wen-Fa Hsu, New Taipei City (TW)

(21) Appl. No.: 13/088,205

(22) Filed: Apr. 15, 2011

(30) Foreign Application Priority Data
Apr. 16, 2010 (TW) 099111935

(51) Int. Cl. G09G 3/36

(52) U.S. Cl. 349/37

(57) ABSTRACT

A method of driving pixels of a liquid crystal display, a pixel driving device, and a liquid crystal display having the same are provided. The liquid crystal display includes a liquid crystal panel and a pixel driving device, wherein the pixel driving device selectively outputs driving signals having different polarity permutations based on the structure of the display units in the liquid crystal panel.

### CROSS-REFERENCE TO RELATED APPLICATION

This application claims priority based on Taiwanese Patent Application No. 099111935, filed on Apr. 16, 2010, the disclosure of which is incorporated herein by reference in its entirety.

### BACKGROUND OF THE INVENTION

1. Field of the Invention

This invention relates to a pixel driving device, a liquid crystal display having the same, and a method of driving pixels of a liquid crystal panel.

2. Description of the Prior Art

Liquid crystal panel is now the mainstream of the current display market, wherein liquid crystal panels are extensively used in consumer electronic products such as liquid crystal displays, televisions, laptop computers, digital photo frames, and mobile phones.

With the increase in resolution, the number of pixels and the corresponding source driver ICs used in the liquid crystal panel also increase. The pixels and the corresponding source lines in the liquid crystal panel have a one-to-one relationship; in other words, every pixel is electrically connected to one source line. For the liquid crystal panel of a given area, the increase in resolution will cause the source lines to take up more space and reduce available area for other important elements, resulting in space concern for disposing the elements. In order to solve the above-mentioned problem, a liquid crystal panel structure in which two pixels share one source line is developed. FIG. 1 is a schematic view of such a liquid crystal panel. As FIG. 1 shows, the liquid crystal panel 10 includes a plurality of odd number pixels 20, a plurality of even number pixels 21, source lines S1, S2, and S3, gate lines G1, G2, G3, and G4 and a source driver 30, wherein the source driver 30 is electrically connected to the source lines S1, S2, and S3 to output driving signals. Furthermore, one odd number pixel 20 and one even number pixel 21 are connected to a same source line from one of the source lines S1, S2, and S3 and to different gate lines. The gate lines G1, G2, G3, and G4 output signals to alternatively drive the odd number pixels 20 and the even number pixels so that the signals can be transmitted through the source lines to drive the liquid crystal of the corresponding pixel. In this way, only one of the odd number pixel 20 and the corresponding even number pixel 21 will accept the driving signal transmitted from the source driver 30.

Liquid crystal contained in the odd number pixel 20 and the even number pixel 21 needs to be driven with signals alternating in polarity or otherwise characteristics of the liquid crystal will be irreversibly altered. For instance, if the driving signal received by the pixel has a positive polarity, then the next signal received by the same pixel needs to have a negative polarity. In addition, the absolute value of voltage of the above-mentioned signals with opposite polarities needs to remain substantially constant in order to avoid altering the working characteristics of the liquid crystal. Furthermore, change in polarity of the driving signals received by the pixels will inevitably create flickers in the images displayed and influence viewers' overall visual experience.

FIG. 2A is a schematic view of the polarity permutation of the driving signals generated by the source driver 30 illustrated in FIG. 1. FIG. 2B is a schematic view illustrating the polarity permutation of the driving signals received by the liquid crystal panel with a 1-to-1 relationship between the pixel and the corresponding source line. On the other hand, FIG. 2C is a schematic view illustrating the polarity permutation of the driving signals received by the liquid crystal panel having a structure with a 2-to-1 relationship between the pixels and the corresponding source line. As FIG. 2B shows, each pixel corresponds to one source line and therefore the polarity permutation of the pixels in the liquid crystal panel corresponds to the polarity permutation illustrated in FIG. 2A, wherein the polarity of the driving signal received by a pixel is opposite to the driving signals adjacent to the pixel. Overall, the pixels have a one dot inversion polarity permutation and can display images with the least amount of visible flickers.

The gate line G1 and G2 corresponding to the odd number pixels 20 and the even number pixels 21, respectively are energized at different time slots. Therefore the polarity permutation of driving signals received by the pixels in those two different liquid crystal panel are different. As such, the driving signals received by the pixels in FIG. 2C have a 1+2 line dot inversion polarity permutation and cause the pixels in FIG. 2C to generate visible flickers which influence the visual experience of viewers.

The description and corresponding figures show that different liquid crystal panels receiving driving signals with the same polarity permutation can display images with different amount of visible flickers and provides different visual experience. Driver integrated circuits designed for different liquid crystal panels can solve the problem mentioned above. However, the solution will increase the associated development cost and manufacture cost. Therefore how to use the same driver integrated circuit to drive pixels of liquid crystal panels with different structures and still achieve an overall one dot inversion polarity permutation is one of the important issues in the display technology.

### SUMMARY OF THE INVENTION

It is an objective of the present invention to provide a pixel driving device and a method of driving liquid crystal panels with different pixel structures to achieve the one dot inversion polarity permutation and generate the corresponding visual effect.

It is another objective of the present invention to provide a liquid crystal device having the pixel driving device and a liquid crystal panel, and a method of driving liquid crystal panels with different pixel structures to achieve the one dot inversion polarity permutation and generate images with corresponding visual effect.

The pixel driving device of the present invention includes a polarity signal generator, a polarity selector, and a driving signal generator, wherein the polarity selector is connected to both the polarity signal generator and the driving signal generator. The polarity selector receives a first polarity signal from the polarity signal generator and a second polarity signal from an external source, wherein the polarity selector outputs one of the first polarity signal and the second polarity signal to the driving signal generator based on a conversion signal. The driving signal generator generates driving signals with polarity permutation corresponding to the polarity signal received and transmits the driving signals to the display units of the liquid crystal panel so that the polarity of the driving signal received by each display unit is different from the polarity of the driving signal received by the adjacent display units. In other words, the pixel driving device adjusts the polarity of the driving signals based on the polarity signal received to achieve a one dot inversion polarity permutation in the display units of the liquid crystal panel and provide a visual effect with less significant flicker.

### BRIEF DESCRIPTION OF THE DRAWINGS

FIG. 1 is a schematic view of a conventional liquid crystal display panel;

FIG. 2A is a schematic view of the polarity permutation of the driving signals generated by the source driver illustrated in FIG. 1;

FIG. 2B and FIG. 2C are schematic views illustrating the polarity permutations of the driving signal received by the display units of the conventional liquid crystal panels with different structures;

FIG. 3 is a schematic view of the liquid crystal display of the present invention;

FIG. 4A is a schematic view illustrating the polarity permutation of the driving signals generated by the pixel driving device illustrated in FIG. 3;

FIG. 4B is a schematic view of the driving signals received by the display units of the liquid crystal panel illustrated in FIG. 4B;

FIG. 5 is a schematic view illustrating a variation of the liquid crystal display illustrated in FIG. 3;

FIG. 6A is a schematic view illustrating the polarity permutation of the driving signals outputted by the pixel driving device illustrated in FIG. 5;

FIG. 6B is a schematic view of the polarity permutation of the driving signals received by the display units of the liquid crystal panel illustrated in FIG. 5;

FIG. 7 is a block diagram of the pixel driving device illustrated in FIG. 3 and FIG. 5;

FIG. 8 is a block diagram of the driving signal generator and the amplifiers illustrated in FIG. 7;

FIG. 9 is a schematic view of a variation of the driving signal generator illustrated in FIG. 8; and

FIG. 10 is a flow chart illustrating the method of driving the liquid crystal panel of the present invention.

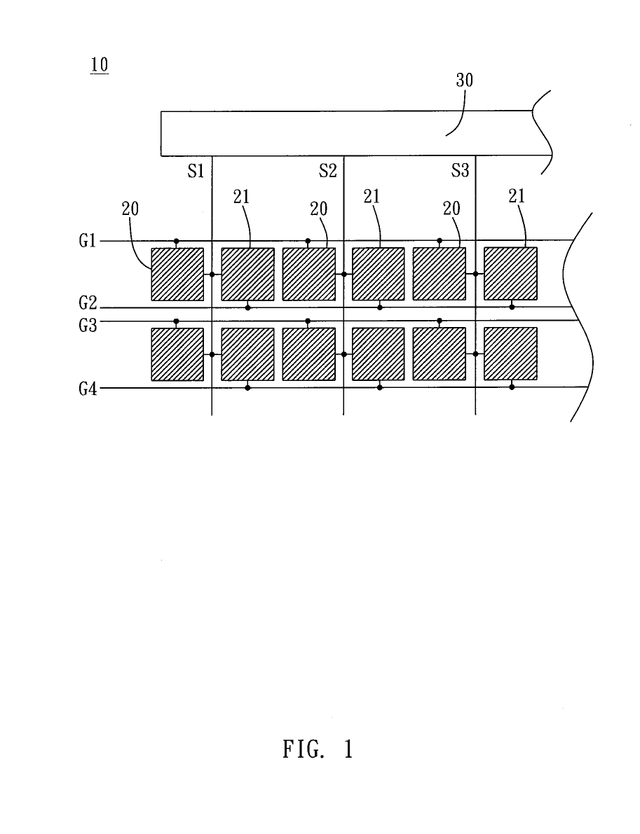

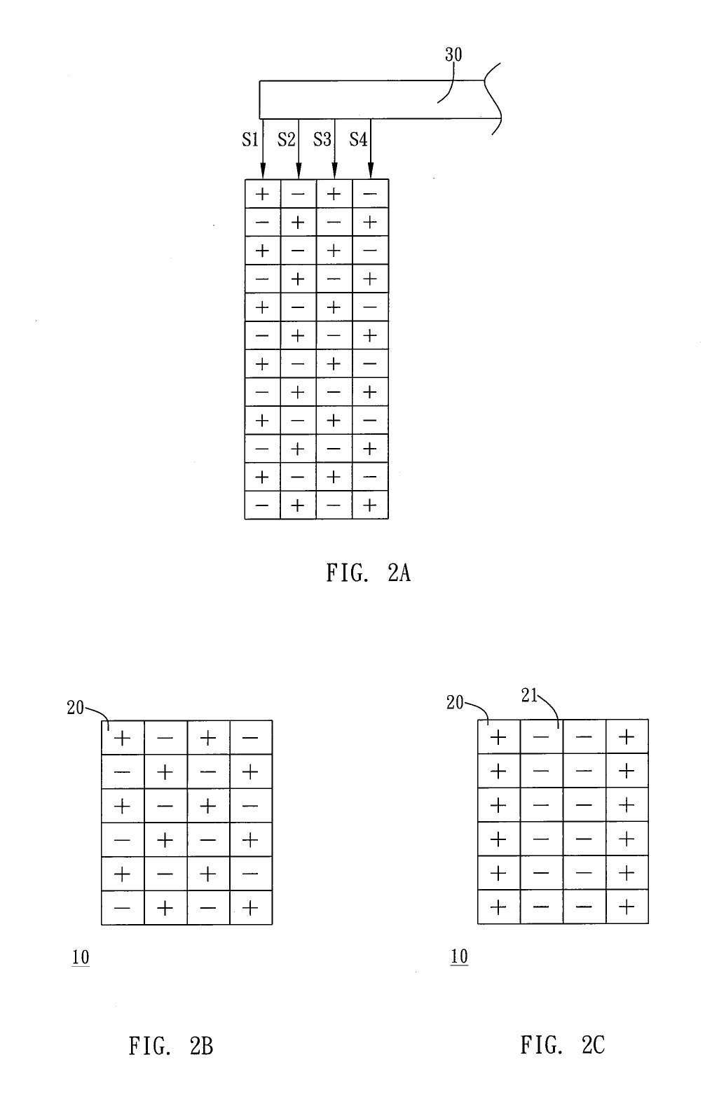

### DETAILED DESCRIPTION OF THE PREFERRED EMBODIMENT

The present invention discloses a method of driving pixels of a liquid crystal display panel, a pixel driving device, and a liquid crystal display having the same. The pixel driving device outputs driving signals to drive the pixels in a liquid crystal panel to generate images, wherein the pixel driving device will periodically reverse the polarity of the driving signals in order to reduce the flicker in the images and their effect on human eyes. Furthermore, each of the driving signals has a driving sequence, wherein the pixel driving device outputs driving signals with different driving sequences based on the structure of the liquid crystal panel.

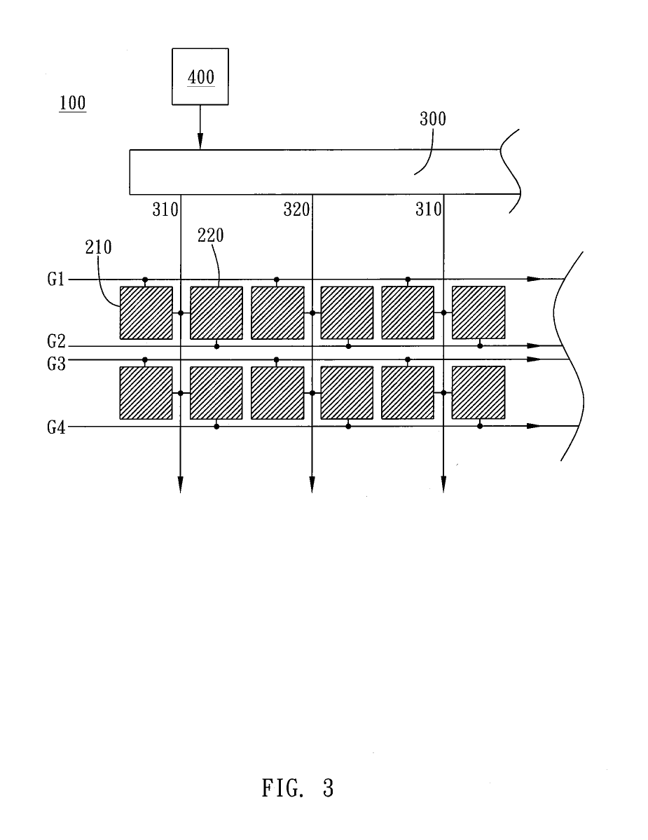

FIG. 3 is a schematic view of the liquid crystal display 100 of the present invention. As FIG. 3 shows, the liquid crystal display 100 includes a liquid crystal panel and a pixel driving device 300, wherein the liquid crystal panel includes a plurality of odd number display units 210 and a plurality of even number display units 220. The pixel driving device 300 includes a plurality of odd number source lines 310 electrically connected to the odd number display units 210 and 220 for transmitting driving signals to the odd number display units 210 and 220 as well as a plurality of even number source lines 320 electrically connected to the even number display units 210 and 220 for transmitting driving signals to the even number display units 210 and 220.

In the embodiment illustrated in FIG. 3, one of the odd number display units 210 and one of the even number display units 220 in the liquid crystal panel are connected to the same source line 310 or 320, wherein the odd number display units 210 are electrically connected to an odd number gate line G1 while the even number display units 220 are electrically connected to an even number gate line G2. The odd number gate line G1 and the even number gate line G2 transmit signals to the gates of the odd number display units 210 and the even number display units 220 at different time slots. In this way, the odd number display unit 210 and the even number display units 220 will activate at different time slots to receive driving signals from the corresponding source lines 310/320. In the present embodiment, a single odd number source line 310 or even number source line 320 corresponds to one odd number display unit 210 and one even number display unit 220 at the same time.

Furthermore, as FIG. 3 shows, the liquid crystal device 100 includes a conversion signal generator 400 electrically connected to the pixel driving device 300 for outputting a conversion signal to the pixel driving device 300. In the present embodiment, the conversion signal is a digital signal and the conversion signal generator 400 outputs the conversion signals with different levels according to the structure of the liquid crystal panel. When one source line 310/320 corresponds to one odd number display unit 210 and one even number display unit 220, the conversion signal generator 400 will output the conversion signal having a first level. When the source line 310/320 corresponds to only one of the display units 210 and 220, the conversion signal generator 400 will output the conversion signal with a second level. In other words, the level of the conversion signal represents the structure of the display units in the liquid crystal panel. In the present embodiment, the first level and the second level respectively correspond to a logic high level and a logic low level, but are not limited thereto.

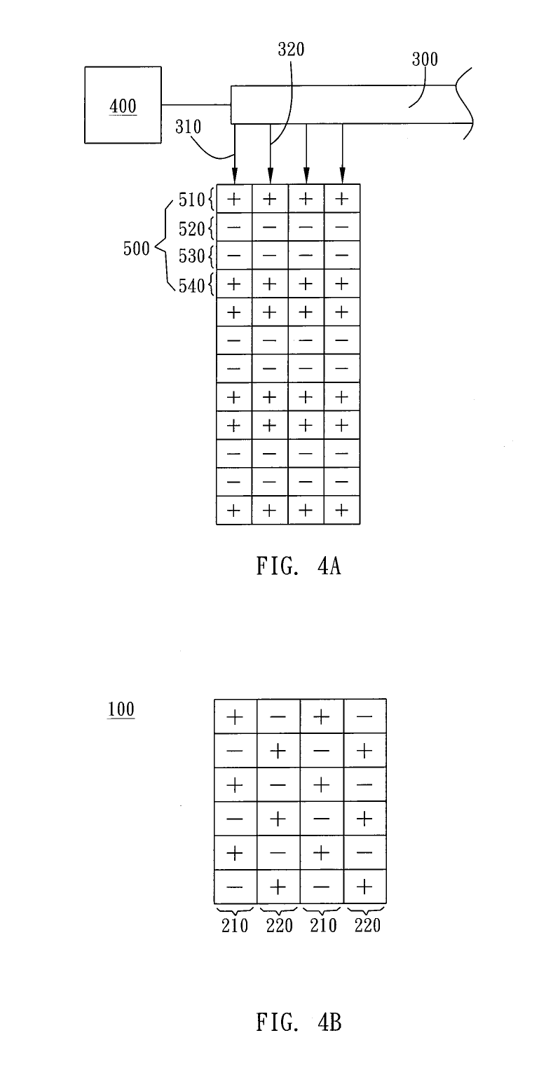

FIG. 4A is a schematic view of the polarity permutation of the driving signals generated by the pixel driving signals, wherein the plus or minus sign in each block illustrated in FIG. 4A represents the polarity of the corresponding driving signal at one time slots. As FIG. 4A shows, the pixel driving device 300 outputs driving signals separately in a first time slot 510, a second time slot 520, a third time slot 530, and a fourth time slot 540, wherein those time slots form a cycling time sequence 500. Furthermore, the odd number display units 210 and the even number display units 220 of the liquid crystal panel of the present embodiment are electrically connected to the odd number source line 310 whereas the conversion signal generator 400 illustrated in FIG. 3 outputs a conversion signal having a first level based on the above-mentioned structure. After receiving the conversion signal having a first level, the polarity of the driving signals generated by the pixel driving device 300 in the first time slot 510 and the fourth time slot 540 is different from the polarity of the driving signals generated in the second time slot 520 and the third time slot 530. In other words, the driving signals in the first time slot 510 and the fourth time slot 540 have the same polarity while the driving signals in the second time slot 520 and the third time slot 530 have the same polarity.

FIG. 4B is a schematic view illustrating the polarities of the driving signals received by the liquid crystal panel, wherein the plus or minus sign in each block illustrated in FIG. 4B represents the polarity of the corresponding driving signal received by the display units. Therefore FIG. 4B can be regarded as a schematic view of the polarity permutation of the driving signals received by the odd number display units 210 and the even number display units 220. As FIG. 4B shows, the polarity of the driving signal received by each of the display units 210, 220 is different from the polarities of the driving signals received by the adjacent display units. In other words, the liquid crystal panel illustrated in FIG. 4B achieves the one dot inversion polarity permutation and generates images with the least flicker.

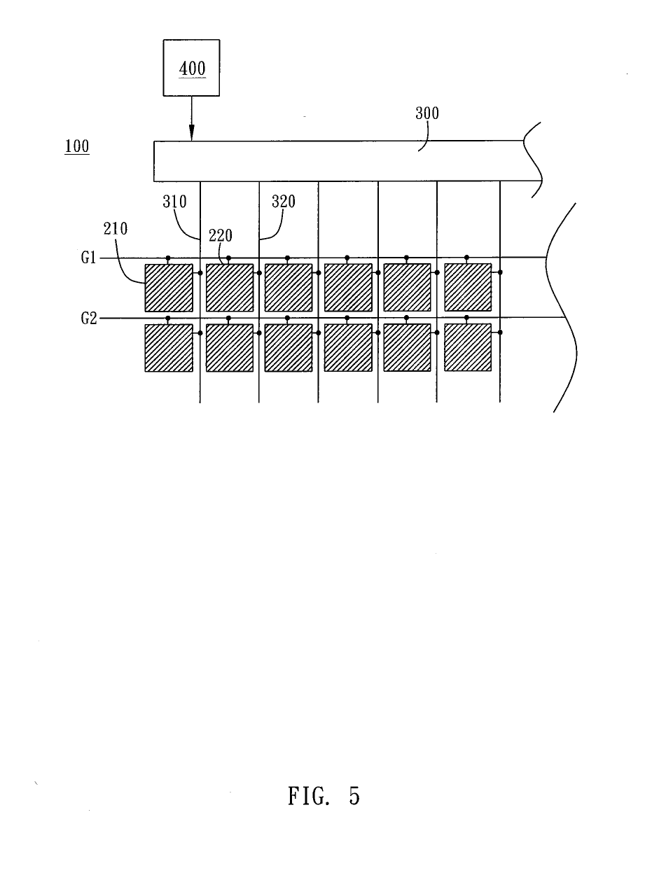

FIG. 5 illustrates a variation of the liquid crystal display 100 illustrated in FIG. 3. As FIG. 5 shows, the odd number display units 210 and the even number display units 220 of the liquid crystal panel are electrically connected to the odd number source line 310 and the even number source line 320 of the pixel driving device 300, respectively, wherein one of the odd number display units 210 and one of the even number display units 220 are connected to the odd number gate line G1. This shows that the display units and the corresponding source lines have a one-to-one relationship. Furthermore, the conversion signal generator 400 illustrated in FIG. 5 is identical to the conversion signal generator 400 illustrated in FIG. 3. However, the conversion signal generator 400 of the present embodiment outputs a conversion signal with a second level to the pixel driving device 300 based on the one-to-one relationship between the display units 210/220 and the corresponding source lines 310/320.

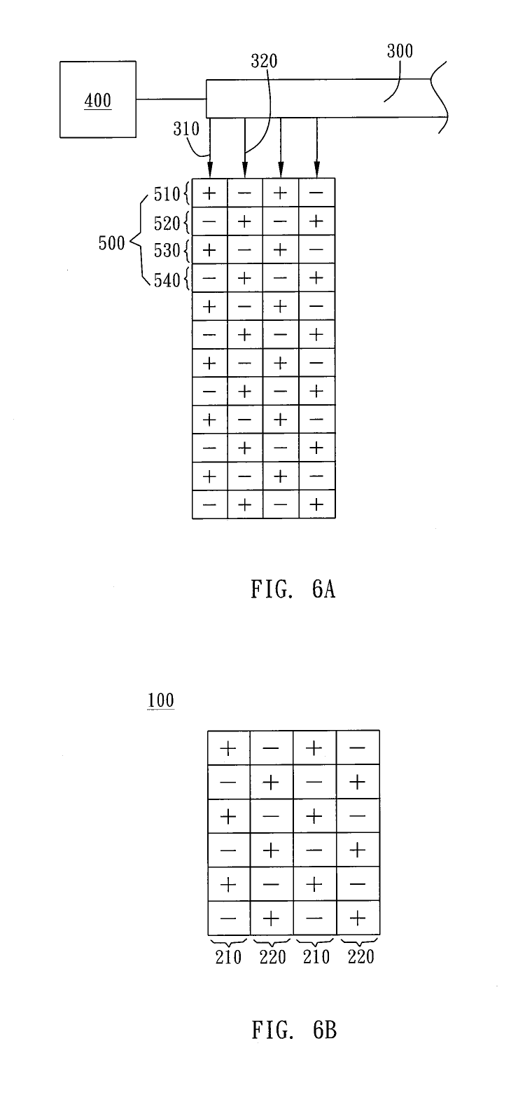

FIG. 6A is a schematic view illustrating the polarity permutation of the driving signals outputted by the pixel driving device 300, wherein the plus or minus sign in the blocks in FIG. 6A represents the polarity of the driving signal at different time slots. In the present embodiment, the pixel driving device 300 outputs driving signals in independent time slots such as a first time slot 510, a second time slot 520, a third time slot 530, a fourth time slot 540, wherein the above-mentioned time slots form a cycling time sequence 500. After receiving the conversion signal with a second level, the polarity of the driving signals outputted by the pixel driving device 300 in the first time slot 510 and the third time slot 530 is different from the polarity of the driving signals outputted in the second time slot 520 and the fourth time slot 540. In other words, the driving signals in the first time slot 510 and the third time slot 530 have the same polarity while the driving signals in the second time slot 520 and the fourth time slot 540 have the same polarities.

FIG. 6B illustrates the polarity permutation of the driving signals received by the liquid crystal panel illustrated in FIG. 5, wherein the plus or minus sign in the blocks illustrated in FIG. 6B represents the polarity of the driving signal received by each of the display units. As FIG. 6B shows, the polarity of the driving signal received by a display unit in one time slot is different from the polarity of the driving signal received by the adjacent display units. Therefore, the liquid crystal panel illustrated in FIG. 6B can achieve a one dot inversion polarity permutation and therefore generate images with the least amount of flickers. This shows that by adjusting and setting the signals outputted by the conversion signal generator 400, the conversion signal generator 400 and the pixel driving device 300 of the present invention can be controlled to drive liquid crystal panels with different structures to achieve the one dot inversion polarity permutation.

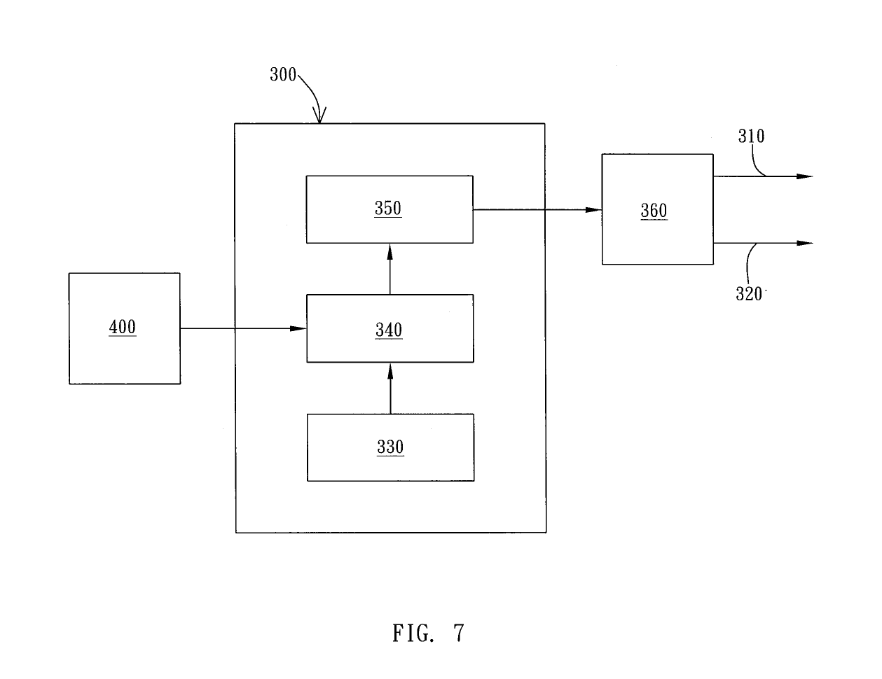

FIG. 7 is a block diagram of the pixel driving device 300 illustrated in FIG. 3 and FIG. 5. As FIG. 7 shows, the pixel driving device 300 includes a polarity signal generator 330, a polarity selector 340, and a driving signal generator 350, wherein the polarity selector 340 is electrically connected to the polarity signal generator 330 and the driving signals generator 350. The polarity selector 340 of the present embodiment receives a first polarity signal and a second polarity signal from the polarity signal generator 330 and selectively transmits one of the first polarity signal and the second polarity signal to the driving signal generator 350 to output a plurality of driving signals to an amplifier 360, wherein the amplifier 360 amplifies the driving signals received and then transmits the amplified driving signals to the odd number display units 210 and the even number display units 220 of the liquid crystal panel such as the one illustrated in FIG. 3. Furthermore, in the present embodiment, the polarity signal generator 330 is used to generate the first polarity signal and the second polarity signal, but is not limited thereto; in different embodiments, the polarity signal generator 330 can only generate the polarity signal while the polarity selector 340 can receive another polarity signal from an external source.

Please refer to both FIG. 4A and FIG. 7. The polarity signal generator 330 outputs a first polarity signal to the polarity selector 340 based on a first polarity permutation, wherein the first polarity permutation refers to the polarity permutation of the driving signals in the first time slot 510, the second times lot 520, the third time slot 530, and the fourth time slot 540 illustrated in FIG. 4A. In other words, when the driving signal generator 300 receives the first polarity signal, the first polarity permutation refers to the arrangement wherein the polarity of the driving signals in the first time slot 510 and the fourth time slot 540 is different from the polarity of the driving signals in the second time slot 520 and the third time slot 530.

As FIG. 7 shows, the polarity selector 340 receives a first polarity signal from the polarity signal generator 330 and a second polarity signal from an external source, wherein the polarity signals mentioned above represent different polarity permutations. In the present embodiment, the second polarity signal includes a second polarity permutation, wherein the second permutation is identical to the permutation illustrated in FIG. 6A at the first time slot 510, the second time slot 520, the third time slot 530, and the fourth time slot 540. In other words, the second polarity permutation refers to the a arrangement where the driving signals have the same polarity in the first time slot 510 and the third time slot 530 and the same polarity in the second time slot 520 and the fourth time slot 540. In the present embodiment, the polarity selector 340 is electrically connected to the conversion signal generator 400 illustrated in FIG. 3 or FIG. 5 to receive a conversion signal, wherein the polarity selector 340 transmits the first polarity signal or the second polarity signal to the driving signal generator 300 based on the conversion signal received so that the driving signal generator 300 can generate driving signals with the polarity permutation corresponding to the polarity signal received. In the present embodiment, the second polarity signal is generated by a device external to the pixel driving device 300, but is not limited thereto; in different embodiments, the polarity signal generator 330 can be used to generate and transmit both the first polarity signal and the second polarity signal to the polarity selector 340.

In the embodiment illustrated in FIG. 7, the polarity selector 340 is electrically connected to the conversion signal generator 400 illustrated in FIG. 3 or FIG. 5 to receive the conversion signal, wherein the polarity selector 340 transmits one of the first polarity signal and the second polarity signal to the driving signal generator 350 based on the conversion signal received. In the present embodiment, when the conversion signal is at a first level, the polarity selector 340 will transmit the first polarity signal to the driving signal generator 350 so that the driving signal generator 350 can generate a plurality of driving signals with the polarity permutation illustrated in FIG. 4A. On the other hand, when the conversion signal is at a second level, the second polarity signal will be transmitted to the driving signal generator 350 so that the driving signal generator 350 can generate a plurality of driving signals with the polarity permutation illustrated in FIG. 6A. The level of the conversion signal represents the structure of display units in the liquid crystal panel and therefore by changing the level of the conversion signal, the pixel driving device 300 can change the polarity permutation of the driving signals transmitted to the liquid crystal panel and still generate the one dot inversion polarity permutation.

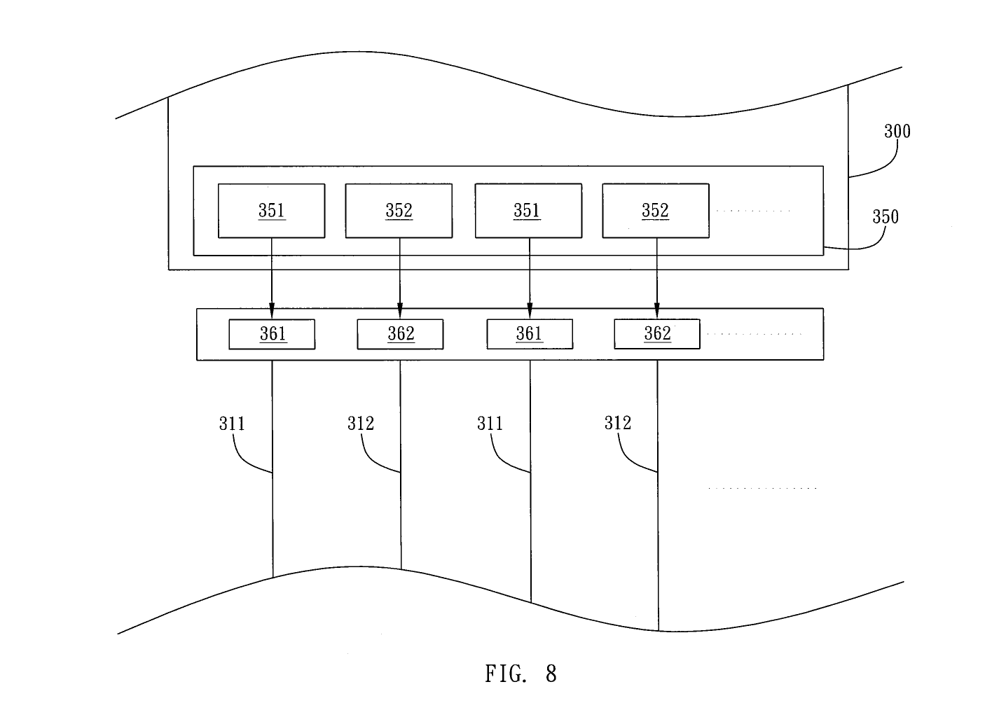

FIG. 8 is a block diagram of the driving signal generator 350 and the amplifier 360 illustrated in FIG. 7. As FIG. 8 shows, the driving signal generator 350 includes a plurality of odd number signal sources 351 and a plurality of even number signal sources 352 while the amplifier 360 includes a plurality of odd number amplifiers 361 and a plurality of even number amplifiers 362. The odd number signal source 351 is between two even number signal sources 352 except for the odd number signal sources at two end of the driving signal generator 350. Similarly, the even number signal source 352 is between two odd number signal sources 352 except for the even number signal sources 352 at two ends of the driving signal generator 350. In the present embodiment, the odd number signal source 351 and the even number signal source 352 are electrically connected to the odd number amplifier 361 and the even number amplifier 362, respectively and transmit the driving signals to the corresponding amplifiers for energy amplification. The odd number amplifier 361 and the even number amplifier 362 amplify the driving signals received and then the amplified driving signals are transmitted to the corresponding display units via the odd number source line 311 and the even number source line 312.

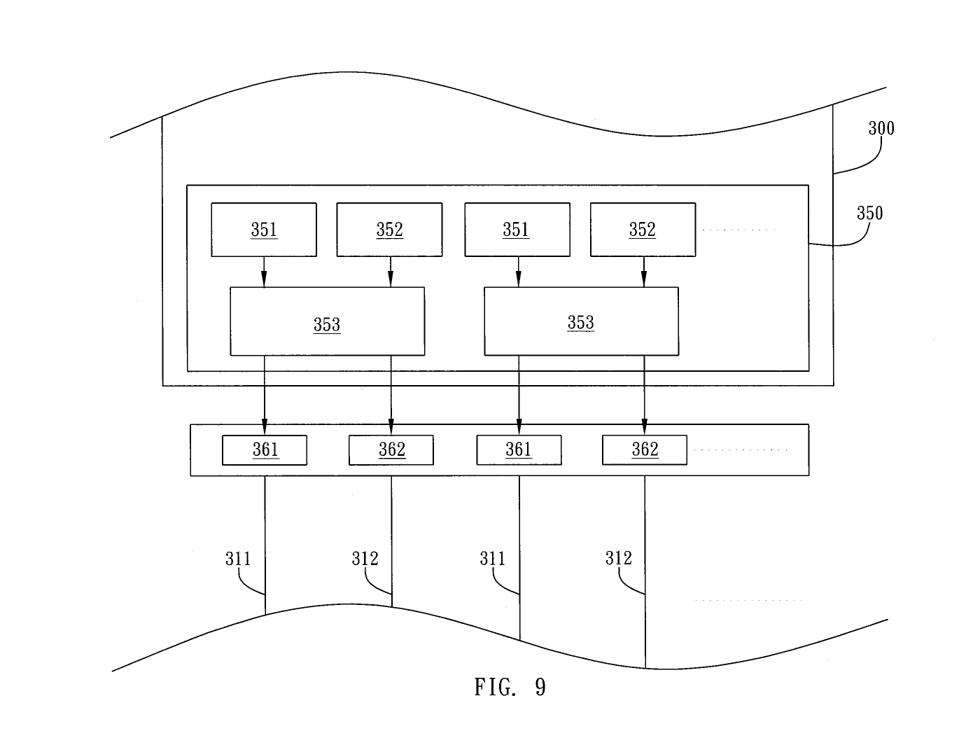

FIG. 9 illustrates a variation of the driving signal generator 350 illustrated in FIG. 8. As FIG. 9 shows, the driving signal generator 350 includes a switch 353 electrically connected to the odd number signal source 351, the even number signal source 352, the odd number amplifier 361, and the even number amplifier 362. In the present embodiment, the odd number signal source 351 and the even number signal source 352 output a positive driving signal and a negative driving signal, respectively, wherein the switch 353 electrically connected to the polarity selector 340 for receiving the first polarity signal or the second polarity signal then selectively transmits the driving signal received to the odd number amplifier 361 and the even number amplifier 362. Upon receiving the first polarity signal, the switch 353 will transmit the driving signals of one of the signal sources 351/352 to the odd number amplifiers 361 and the even number amplifiers 362. In this way, the odd number amplifier 361 and the even number amplifier 362 amplify and output the driving signals with the same polarity. Furthermore, upon receiving the second polarity signal, the switch 353 will transmit the driving signals (with different polarities) from signal sources 351 and 352 to the odd number amplifiers 361 as well as the even number amplifiers 362. In this way, the odd number amplifiers 361 and the even number amplifiers 362 will amplify and transmit the driving signal with different polarities.

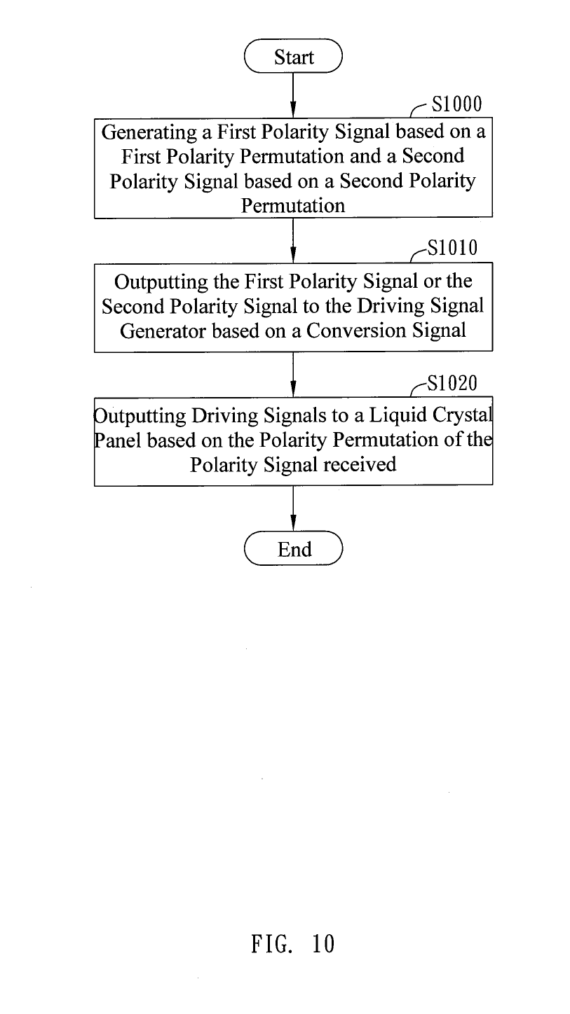

FIG. 10 is a flow chart illustrating a method of driving the pixels of the liquid crystal displays of the present invention. As FIG. 10 shows, the method includes step S1000 of generating a first polarity signal based on a first polarity permutation and generating a second polarity signal based on a second polarity permutation. In the present embodiment, the first polarity signal and the second polarity signal are used to instruct a driving signal generator to generate driving signals with polarities corresponding to the polarity signal received to drive liquid crystal panels with different structures. Step S1010 includes outputting one of the first polarity signal and the second polarity signal to the driving signal generator based on a conversion signal, wherein the driving signal generator use the conversion signal as a reference for creating the polarity permutation of the driving signals. In the present embodiment, the conversion signal is a digital signal with two levels and each level represents one liquid crystal panel with a specific structure. In other words, the first polarity signal and the second polarity signal represent two liquid crystal panels with different structures. In the present embodiment, the liquid crystal panel includes a plurality of odd number display units and a plurality of even number display units while the driving signal generator includes a plurality of odd number source lines and a plurality of even number source lines. In different embodiments, the odd number display units and the even number display units can be connected to the same source line or different source lines. Step S1020 includes outputting driving signals to a liquid crystal panel based on the polarity permutation of the polarity signal received in order to achieve a one dot inversion polarity permutation and reduce the flickers generated by the change of polarity in the pixels of the liquid crystal panel.

In the embodiment illustrated in FIG. 10, the driving signal generator outputs driving signals to the liquid crystal panel via the odd number source lines and the even number source lines. When the odd number display units and the even number display units of the liquid crystal panel are electrically connected to the same source lines, the driving signal generator will output driving signals of the same polarity via the odd number source lines and the even number source lines, after receiving a first polarity signal. When the odd number display units and the even number display units are connected to the odd number source lines and the even number source lines, respectively, the driving signal generator will output driving signals of different polarities via the odd number source lines and the even number source lines, after receiving a second polarity signal.

Furthermore, in the present embodiment, the driving signal generator outputs driving signals in a cycling time sequence, wherein the cycling time sequence includes a first time slot, a second time slot, a third time slot, and a fourth time slot. When the driving signal generator receives a first polarity signal, the polarity of the driving signals generated in the first time slot and the fourth time slot is different from the polarity of the driving signals generated in the second time slot and the third time slot. On the other hand, when the driving signal generator received a second polarity signal, the polarity of the driving signals generated in the first time slot and the third time slot is different from the polarity of the driving signals generated in the second time slot and the fourth time slot.

The above description above show that the conversion signal can be changed based on the structure of the liquid crystal panel to instruct the driving signal generator to generate driving signals with different polarity permutations in order to achieve the one dot inversion polarity permutation in the display units of the liquid crystal panel and reduce the amount of flickers in the images generated by the liquid crystal panels.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A pixel driving device, comprising:
a polarity signal generator outputting a first polarity signal based on a first polarity permutation;
a polarity selector accepting the first polarity signal, a second polarity signal corresponding to a second polarity permutation, and a conversion signal and then selectively outputting the first polarity signal or the second polarity signal based on the conversion signal; and
a driving signal generator electrically connected to the polarity selector to accept the first polarity signal or the second polarity signal;
wherein the driving signal generator outputs a plurality of first driving signals based on the first polarity permutation after receiving the first polarity signal or outputs a plurality of second driving signals based on the second polarity permutation after receiving the second polarity signal, the first driving signals and the second driving signals correspond to different polarity permutations.

2. The pixel driving device of claim 1, wherein the driving signal generator includes an odd number signal source and an even number signal source, when the driving signal generator receives the first polarity signal, the odd number signal source and the even number signal source output the first driving signals with same polarity; when the driving signal generator receives the second polarity signal, the odd number signal source and the even number signal source output the second driving signals with different polarities.

3. The pixel driving device of claim 2, further including an odd number amplifier and an even number amplifier, wherein the odd number signal source is electrically connected to the odd number amplifier and the even number signal source is electrically connected to the even number amplifier, the odd number amplifier and the even number amplifier accept and amplify the first driving signals or the second driving signals generated by the driving signal generator.

4. The pixel driving device of claim 3, wherein the driving signal generator includes a switch electrically connected to the odd number signal source, the even number signal source, the odd number amplifier, and the even number amplifier, the switch of the driving signal generator receives the first driving signal or the second driving signal from the odd number signal source and selectively transmits the first driving signal or the second driving signal received to at least one of the odd number amplifier and the even number amplifier.

5. The pixel driving device of claim 1, wherein the polarity signal generator outputs the first polarity signal in a cycling time sequence based on the first polarity permutation, the cycling time sequence includes a first time slot, a second time slot, a third time slot, and a fourth time slot, a polarity of the first polarity signal in the first time slot and the fourth time slot is different from the polarity of the first polarity signal in the second time slot and the third time slot.

6. A liquid crystal display, comprising:
a liquid crystal display panel including a plurality of odd number display units and a plurality of even number display units; and
a pixel driving device including:
a polarity signal generator outputting a first polarity signal based on a first polarity permutation;
a polarity selector accepting the first polarity signal, a second polarity signal corresponding to a second polarity permutation, and a conversion signal and then selectively outputting the first polarity signal or the second polarity signal based on the conversion signal; and
a driving signal generator electrically connected to the polarity selector to accept the first polarity signal or the second polarity signal;
wherein the driving signal generator outputs a plurality of first driving signals based on the first polarity permutation after receiving the first polarity signal or outputs a plurality of second driving signals based on the second polarity permutation after receiving the second polarity signal, the first driving signals and the second driving signals correspond to different polarity permutations.

7. The liquid crystal display of claim 6, wherein the driving signal generator includes an odd number signal source and an even number signal source; when the driving signal generator receives the first polarity signal, the odd number signal source and the even number signal source output the first driving signals with same polarity; when the driving signal generator receives the second polarity signal, the odd number signal source and the even number signal source output the second polarity signals with different polarities.

8. The liquid crystal display of claim 7, further including an odd number amplifier and an even number amplifier, wherein the odd number signal source is electrically connected to the odd number amplifier and the even number signal source is electrically connected to the even number amplifier, the odd number amplifier and the even number amplifier accept and amplify the first driving signals or the second driving signals generated by the driving signal generator.

9. The liquid crystal display of claim 8, wherein the driving signal generator includes a switch electrically connected to the odd number signal source, the odd number amplifier, and the even number amplifier, the switch of the driving signal generator receives the first driving signal or the second driving signal from the odd number signal source and selectively transmits the first driving signal or the second driving signal received to at least one of the odd number amplifier and the even number amplifier.

10. A method for driving pixels of a liquid crystal display panel, comprising steps of:
generating a first polarity signal based on a first polarity permutation;
outputting one of the first polarity signal and a second polarity signal based on a conversion signal, wherein the second polarity signal corresponds to a second polarity permutation;
outputting a plurality of first driving signals based on the first polarity permutation after receiving the first polarity signal; and
outputting a plurality of second driving signals based on the second polarity permutation after receiving the second polarity signal;
wherein the first driving signals and the second driving signals correspond to different polarity permutations.

11. The method of claim 10, wherein the step of outputting polarity signals includes:
outputting the first driving signals with same polarity via an odd number source line and an even number source line after receiving the first polarity signal; and
outputting the second driving signals with different polarities via the odd number source line and the even number source line after receiving the second polarity signal.

12. The method of claim 10, further including outputting the first driving signal in a cycling time sequence, wherein the cycling time sequence includes a first time slot, a second time slot, a third time slot, and a fourth time slot, a polarity of the first polarity signal in the first time slot and the fourth time slot is different from the polarity of the first polarity signal in the second time slot and the third time slot.
